(19) United States
(12) Patent Application Publication
(10) Pub. No.: US 2025/0205945 A1
(43) Pub. Date: Jun. 26, 2025

(54) SYSTEM AND METHOD OF OVERMOLDING A PALNUT INTO A PANEL ASSEMBLY OF AN AUTOMOTIVE COMPONENT

(71) Applicant: GM Global Technology Operations LLC, Detroit, MI (US)

(72) Inventors: Sachin C. Pagare, New Nashik (IN); Marcel Taran, Novi, MI (US); Scott Marx, Burton, MI (US); Abid Rahman, Washington, MI (US)

(73) Assignee: GM Global Technology Operations LLC, Detroit, MI (US)

(21) Appl. No.: 18/396,203

(22) Filed: Dec. 26, 2023

(51) Int. Cl. B29C 45/14; B29C 45/17; B29C 45/20; B29C 45/40; B29K 705/00; B29L 31/30

(52) U.S. Cl. CPC B29C 45/14065; B29C 45/14008; B29C 45/1756; B29C 45/20; B29C 45/40; B29C 2045/14139; B29K 2705/00; B29L 2031/30

(57) ABSTRACT

A panel assembly for an automotive component has a panel. The panel includes a panel body having a first side and a second side formed on an opposite side from the first side, and an interior wall extending between the first side and the second side to define an aperture extending at least partially through the panel body, the interior wall including a channel formed therein. The panel assembly further has a palnut including an interior portion having a plurality of teeth cooperating to define a fastener opening and a flange surrounding the interior portion. The flange is received within the channel formed in the interior wall of the body.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an injection-molded panel disposed on an automotive component of a vehicle, including a system and a method for embedding a palnut within the panel.

Palnuts are incorporated in the designs of many vehicle components and provide a means of attaching bolts or other fasteners to the vehicle component to facilitate vehicle manufacturing. For example, a palnut may be incorporated in the acoustic cover of an engine, transmission, or drive unit. Continuing with this example, when the acoustic cover is installed on a vehicle component during the vehicle assembly process, bolts are fastened through the palnut to mechanically connect the acoustic cover to the vehicle component.

During the manufacturing process of the vehicle component and corresponding panel, palnuts may be attached to the panel or vehicle component using adhesive. However, adhesively attached palnuts may detach from the panel or vehicle component during shipment or assembly. This results in delayed vehicle assembly due to the need to reattach the palnut to the panel or vehicle component, or source a new palnut entirely to replace the missing palnut.

### SUMMARY

An aspect of the disclosure provides a panel assembly for an automotive component. The panel assembly includes a panel. The panel includes a panel body having a first side and a second side formed on an opposite side from the first side. The panel also includes an interior wall extending between the first side and the second side. The interior wall defines an aperture. The aperture extends at least partially through the panel body. The interior wall includes a channel formed therein. The panel assembly also includes a palnut. The palnut includes an interior portion having a plurality of teeth cooperating to define a fastener opening. The palnut also includes a flange surrounding the interior portion. The flange is received within the channel formed in the interior wall of the body.

Implementations of the disclosure may include one or more of the following optional features. In some examples, the palnut may be a PV style palnut.

In some implementations, the flange may define a flange width extending radially outwardly from the interior portion to a peripheral edge, the flange width being variable along a perimeter of the palnut. The plurality of teeth may be arranged in a hexagon orientation and may define the fastener opening. Additionally or alternatively, the palnut may be one of a triangular palnut or a rectangular palnut.

The aperture of the panel body may have a hexagonal cross-sectional shape. Additionally or alternatively, the flange of the palnut may extend a first distance into the panel body at a first location of the palnut and a different second distance into the panel body at a second location of the palnut.

Another aspect of the disclosure provides a panel assembly system for an automotive component. The system includes a mold assembly. The mold assembly includes an ejector die having a surface, a plateau disposed on the surface, a center post disposed on the plateau, an orientation post disposed on the plateau and offset from the center post, and a cover die. The system also includes a palnut having an interior portion including a plurality of teeth cooperating to define a fastener opening. The palnut also includes a flange surrounding the interior portion. The center post is received in the fastener opening and the orientation post is received between adjacent ones of the plurality of the teeth.

Implementations of this aspect of the disclosure may include one or more of the following optional features. In some examples, the ejector die and the cover die may mate together to form a cavity. Further, the palnut may be a PV style palnut. Additionally or alternatively, the flange may define a flange width extending radially outwardly from the interior portion to a peripheral edge, the flange width being variable along a perimeter of the palnut.

The plurality of teeth may be arranged in a hexagon orientation and may define the fastener opening. Further, the fastener opening may be sized to accept the center post, and a space between the plurality of teeth may be sized to accept the orientation post. Additionally or alternatively, the palnut may be one of a triangular palnut or a rectangular palnut.

An additional aspect of the disclosure provides a method of making a panel for an automotive component. The method includes fixing a palnut to an ejector die. The palnut includes an interior portion having a plurality of teeth cooperating to define a fastener opening. The palnut also includes a flange surrounding the interior portion. The method includes mating a cover die to the ejector die to form a cavity, injecting liquid plastic into the cavity via an injection port disposed in the ejector die to form a panel body at least partially encapsulating the flange of the palnut, allowing the liquid plastic to cure and solidify over a period of time within the cavity, resulting in a panel, and removing the ejector die and the cover die from the panel.

Implementations of this aspect of the disclosure may include one or more of the following optional features. In some examples, the interior portion of the palnut may be located outside of the cavity. The flange may define a flange width extending radially outwardly from the interior portion to a peripheral edge, the flange width being variable along a perimeter of the palnut. Additionally or alternatively, the flange of the palnut may be located within the cavity.

The ejector die may include a plateau and a center post extending from the plateau. The method may further include arranging the palnut on the plateau with the center post received within the fastener opening.

In one configuration, the ejector die may further include an orientation post extending from the plateau and offset from the center post. The palnut may be arranged on the plateau with the orientation post received between adjacent ones of the teeth.

### BRIEF DESCRIPTION OF THE DRAWINGS

The drawings described herein are for illustrative purposes only of selected configurations and are not intended to limit the scope of the present disclosure.

FIG. 1 is a perspective view of an automotive component including a panel assembly situated on the automotive component, the panel assembly including a panel and a palnut installed within a panel body;

FIG. 2 is an enlarged partial perspective view of the panel assembly with the palnut installed within the panel body;

FIG. 3 is a cross-sectional view of the panel assembly including the palnut installed within the panel body, taken along Line 3-3 of FIG. 2;

FIG. 4 is an exploded view of an example of a panel assembly system, the panel assembly system including the palnut, the panel, and a mold assembly for forming the panel assembly of FIG. 1, the mold assembly including a cover die and an ejector die;

FIG. 5 is an enlarged partial perspective view of an ejector die for molding the panel of FIG. 1;

FIG. 6 is an enlarged partial perspective view of the ejector die of FIG. 5 with the palnut situated on a center post and an orientation post of the ejector die;

FIG. 7 is a partial cross-sectional view of the mold assembly of FIG. 4, showing the palnut and a cover die spaced apart from the ejector die;

FIG. 8 is a partial cross-sectional view of the mold assembly of FIG. 4, showing the cover die mated to the ejector die, forming a cavity;

FIG. 9 is a cross-sectional view of the mold assembly of FIG. 4, showing the panel assembly formed within the cavity via injection molding;

FIG. 10 is an exploded view of another example of a mold assembly for forming a panel assembly according to the principles of the present disclosure;

FIG. 11 is an exploded view of another example of a mold assembly for forming a panel assembly according to the principles of the present disclosure; and

FIG. 12 is an exploded view of another example of a mold assembly for forming a panel assembly according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

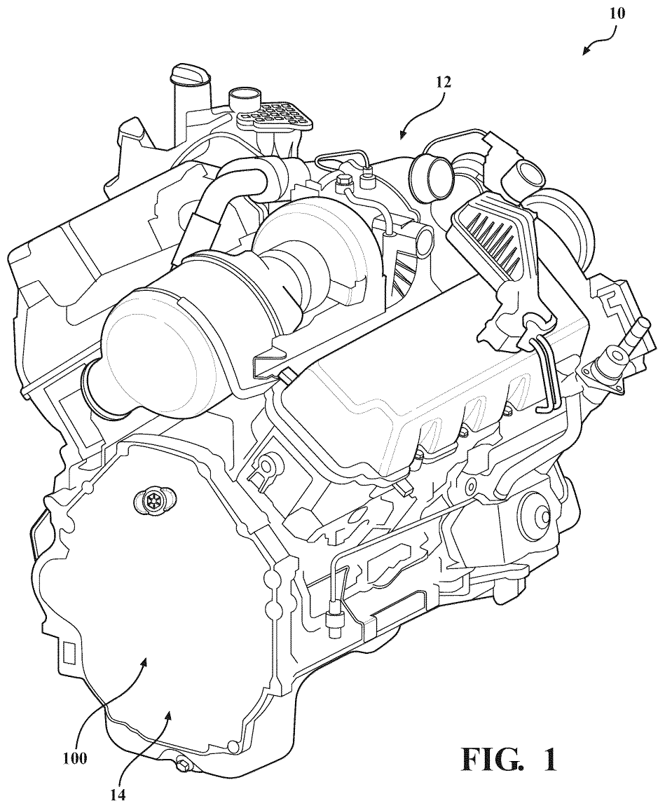

Referring to FIG. 1, an example automotive component 12 is provided that would be included in the build of a vehicle 10. While the automotive component 12 shown in FIG. 1 is an engine, it can be appreciated that the automotive component 12 could be anything that may be included in the general makeup of a vehicle 10, including, but not limited to, an engine, transmission, or drive unit. The automotive component 12 includes a panel assembly 14, which is attached to the automotive component 12. The panel assembly 14 may be used to cover a portion of the automotive component 12, to fasten pieces of the automotive component 12 together, or provide shielding to the automotive component 12, among other uses applicable to the specific application.

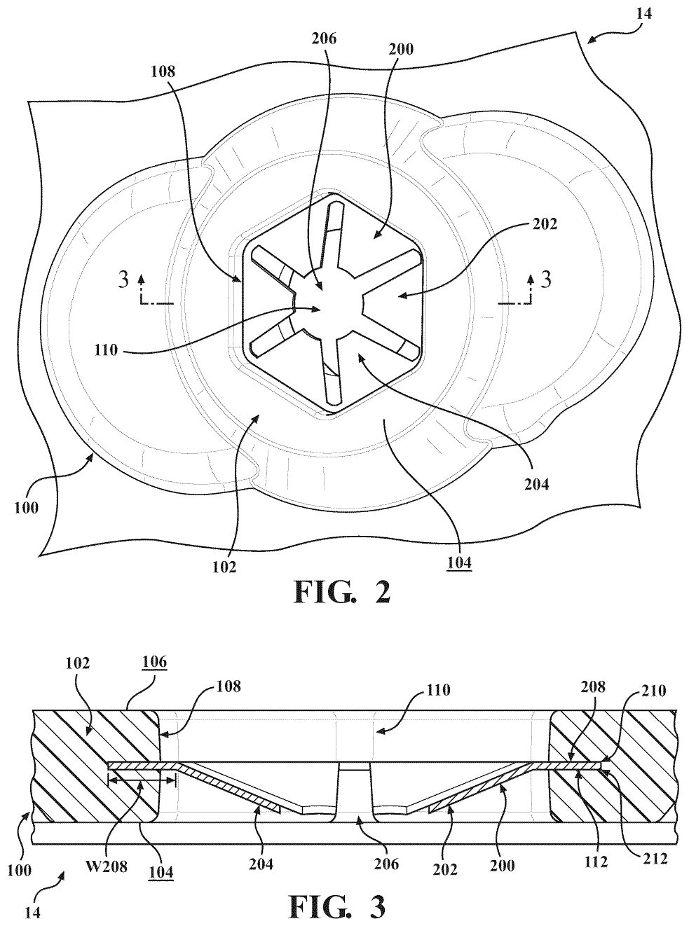

Referring to both FIG. 1 and FIG. 2, the panel assembly 14 includes a panel 100 and a panel body 102. The panel body 102 includes a first side 104 and a second side 106 formed on the opposite side from the first side 104. In the example shown in FIG. 2, the first side 104 is the exterior portion of the panel body 102 relative to the automotive component 12. However, it is not necessary nor required for the first side 104 to face the exterior of the automotive component 12. The panel body 102 includes an aperture 110 extending through the panel body 102 from the first side 104 to the second side 106. As shown, the aperture 110 is defined by an interior wall 108 extending between the first side 104 and the second side 106. The interior wall 108 is continuous and defines a hexagonal cross-section of the aperture 110.

Referring still to FIG. 1, a PV style palnut 200 is disposed within the aperture 110 of the panel 100. The palnut 200 is of a different material than the material of the panel 100. For example, the palnut 200 may include a metallic material, while the panel 100 may include a plastic or polymeric material. The palnut 200 includes an interior portion 202 including a plurality of teeth 204. When assembled to the panel 100, the teeth 204 are entirely contained within the aperture 110. The teeth 204 cooperate to define a fastener opening 206 at the center of the interior portion 202 of the palnut 200. This fastener opening 206 is the location where a fastening device, such as a bolt, may be inserted, whereby the teeth 204 engage the fastening device to secure the fastening device in place by interacting with the threads of the fastening device. To facilitate this interaction between the teeth 204 and the fastening device, the teeth 204 must be able to flex independently of one another to accommodate helix-shaped threads of the fastening device.

Referring now to FIG. 3, the interior wall 108 includes a channel 112 formed within the panel body 102. The channel 112 is disposed between the first side 104 and the second side 106 of the panel body 102. In this example, the second side 106 is the interior portion of the panel body 102 that faces inward towards the automotive component 12. The palnut 200 includes a flange 208 that extends radially outwardly from the interior portion 202. It can be appreciated that the teeth 204 of the palnut 200 may be biased upwardly or downwardly from the flange 208 to accommodate the threading and flexing nature of the teeth 204 when a fastening device is inserted in the fastener opening 206. The flange 208 is received by the channel 112 to secure the palnut 200 rigidly in its position within the aperture 110. The flange 208 surrounds the interior portion 202 of the palnut 200 and extends radially outwardly from the interior portion 202 to a peripheral edge 210, the peripheral edge 210 defining a perimeter 212 of the palnut 200.

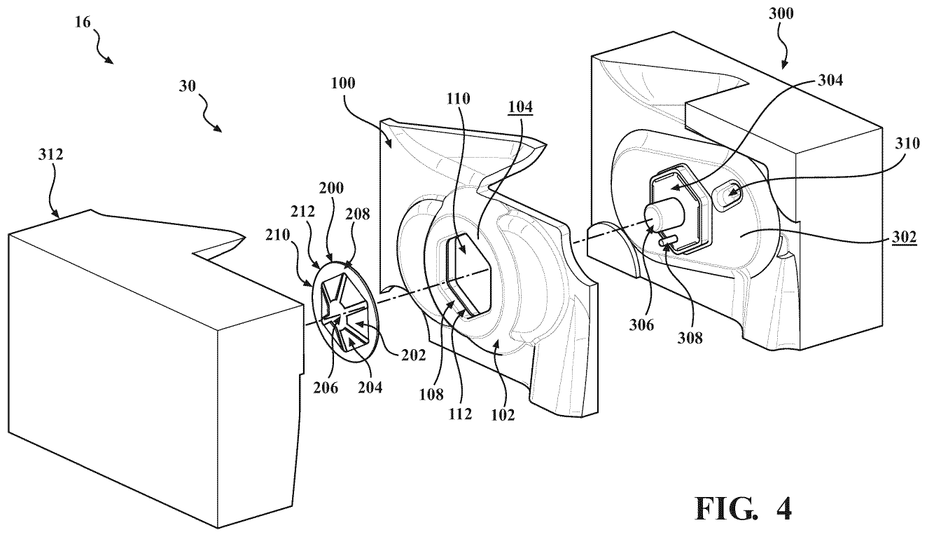

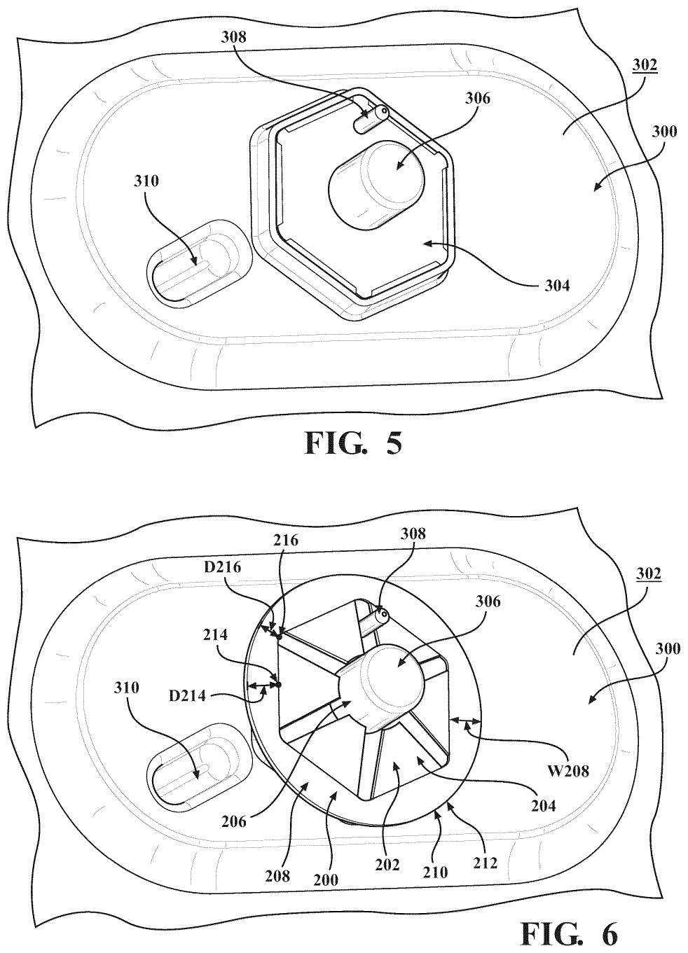

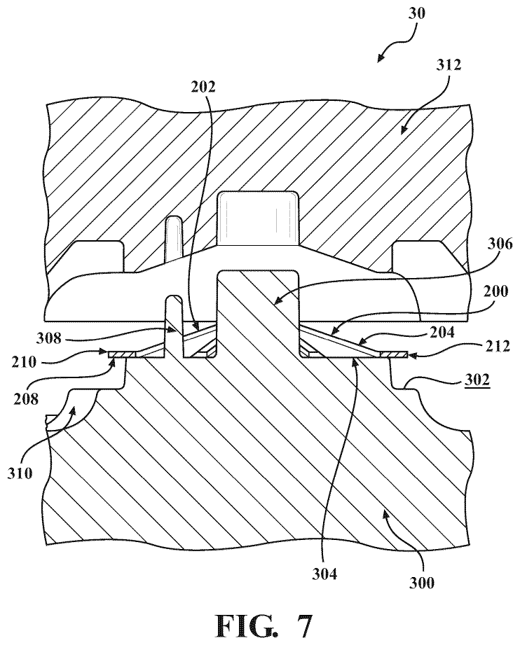

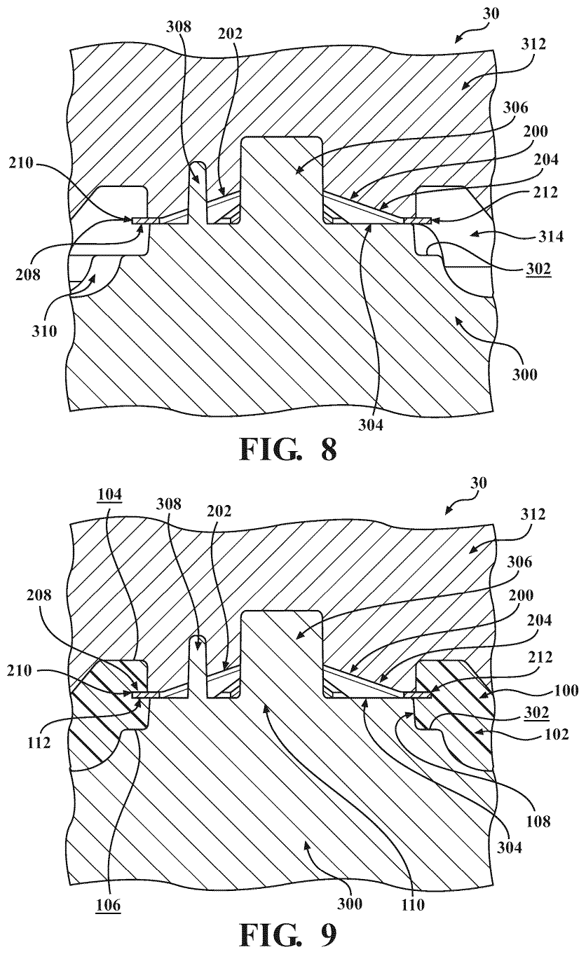

With reference now to FIG. 4, an example mold assembly 30 for forming the panel assembly 14 includes an ejector die 300 and a cover die 312. The mold assembly 30 is a component of a panel assembly system 16, the panel assembly system 16 also including the palnut 200 and the panel 100. Referring to FIGS. 5 and 6, a detailed view of the ejector die 300 is shown. The ejector die 300 includes a mold cavity surface 302 and a plateau 304 protruding from the mold cavity surface 302. Furthermore, an injection port 310 is also disposed within the mold cavity surface 302 of the ejector die 300, the injection port 310 facilitating the introduction and flow of a molten plastic or resin material. A center post 306 and an orientation post 308 are disposed on the plateau 304, the orientation post 308 offset from the center post 306. The size of the center post 306 is intended to match the size of the fastener opening 206 of the palnut 200, allowing the center post 306 to extend through the fastener opening 206 when the palnut 200 is placed on the ejector die 300. The size of the orientation post 308 is intended to match the space allotted between adjacent ones of the teeth 204 of the palnut 200. The center post 306 ensures that the palnut 200 is placed in the necessary location to facilitate the intended result of the injection molding process, while the orientation post 308 fixes the palnut 200 into a correct orientation on the ejector die 300.

The palnut 200 has a flange width W₂₀₈ that is variable along the perimeter 212. In this example, the interior portion 202 of the palnut 200 is defined by a hexagonal shape, the plurality of teeth 204 arranged in a hexagon orientation, while the perimeter 212 is that of a circular shape. Because of the two different shapes incorporated into the design of the palnut 200, the flange width W₂₀₈ is variable. Continuing with this hexagonal palnut 200 example, the flange width W₂₀₈ is greatest at the center base of one of the teeth 204, referred to as a first location 214, while the flange width W₂₀₈ is smallest at a location in-between a pair of teeth 204, referred to as a second location 216. The flange width W₂₀₈ will gradually increase from the second location 216, around the perimeter 212, until the first location 214 is reached, at which point, the flange width W₂₀₈ decreases in a direction towards a subsequent second location 216. This varying flange width W₂₀₈ pattern will repeat around the perimeter 212 of the palnut 200.

As noted above, referring once again to FIGS. 3-6, the flange 208 extends into the panel body 102, facilitated by the channel 112 disposed in the interior wall 108. It can be appreciated that the distance the flange 208 extends into the panel body 102 corresponds to the flange width W₂₀₈ and may not be uniform around the perimeter 212 of the palnut 200. The channel 112 only accepts the flange 208, leaving the interior portion 202 exposed within the aperture 110 of the panel 100. Because the interior portion 202 of the palnut 200 is defined by a hexagonal shape, and the perimeter 212 is circular, the variable flange width W₂₀₈ dictates the distance the flange 208 extends into the panel body 102. For example, the distance between the first location 214 and the perimeter 212 is a first distance D₂₁₄, and the distance between the second location 216 and the perimeter 212 is a second distance D₂₁₆. Based on the shape of the palnut 200 in this example, the first distance D₂₁₄ is greater than the second distance D₂₁₆, meaning that the flange 208 will extend a greater distance into the panel body 102 at the first location 214 compared to the distance the flange 208 extends into the panel body 102 at the second location 216. The non-uniformity of the amount the flange 208 extends into the panel body 102 around the perimeter 212 of the palnut 200 mechanically locks the palnut into its orientation, disabling the ability for the palnut 200 to spin when the flange 208 is contained within the channel 112.

With reference now to FIGS. 6-9, when the palnut 200 is placed on the ejector die 300 with the center post 306 extending through the fastener opening 206 and the orientation post 308 extending through the space between the teeth 204, the palnut 200 is resting on the plateau 304. The plateau 304 has a perimeter that is shaped to match the interior portion 202 of the palnut 200. This allows the entirety of the flange 208 to extend beyond the boundaries of the plateau 304 while keeping the entirety of the interior portion 202 positioned on the plateau 304. Because the plateau 304 is disposed on the mold cavity surface 302 of the ejector die 300, when the palnut 200 is installed on the ejector die 300, a space is created between the flange 208 and the mold cavity surface 302.

The cover die 312 may be used in conjunction with the ejector die 300 to form a mold cavity 314 when mated together. The cover die 312 is shaped to accommodate the center post 306, the orientation post 308, and the palnut 200. The mold cavity 314 encapsulates the flange 208 of the palnut 200 while sealing and separating the interior portion 202 from the mold cavity 314 due to the shape of the plateau 304 matching the shape of the interior portion 202. The positioning of the injection port 310 in the ejector die 300 allows the injection port 310 to be contained within the bounds of the cavity 314. When the cavity 314 is filled with liquid plastic via injection molding, and is permitted to cure, the panel 100 is formed.

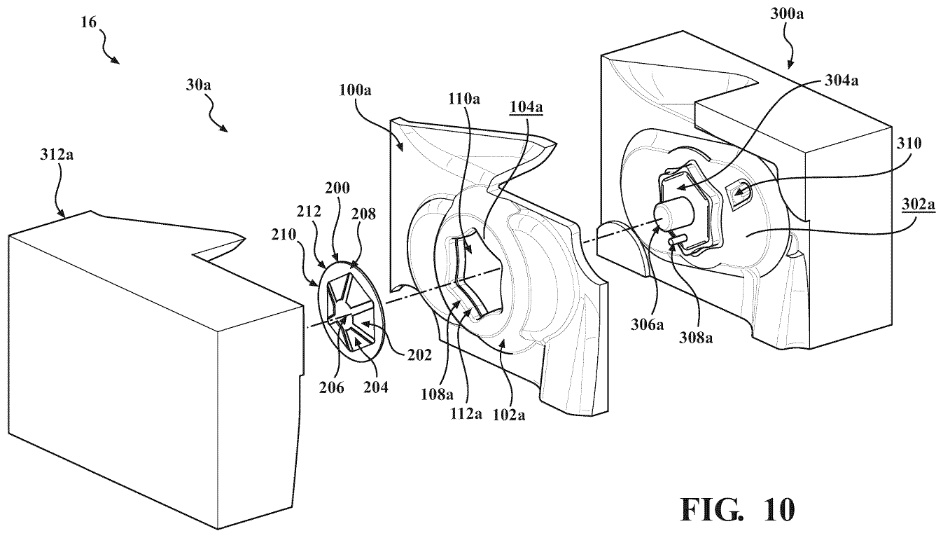

With reference now to FIGS. 10-12, alternate examples of mold assemblies 30a-30c are provided, including a portion of the panel assembly system 16. In these examples, the shape and configuration of the palnut 200, 200b-200c, the ejector die 300a-300c, the cover die 312a-312c, the panel assembly 14a-14c, and the panel 100a-100c may be modified while retaining the identical concepts described above with respect to the mold assembly 30 and panel 100. Additionally, the changes to the mold assemblies 30a-30c may require corresponding changes to the shape and configuration of the orientation post 308a-308c, the center post 306a-306c, the plateau 304a-304c, the mold cavity surface 302a-302c, the panel body 102a-102c, the first side 104a-104c, the second side 106a-106c, the interior wall 108a-108c, the aperture 110a-110c, and the channel 112a-112c. While the example mold assembly 30 and panel 100 includes a palnut 200 having an interior portion 202 shaped hexagonally, coinciding with a hexagonal aperture 110, a hexagonal plateau 304, and a matching cover die 312 configuration, a mold assembly 30a including a plateau 304a having hexagon-like shape with arcuate edges that taper inwards may also be used, as shown in FIG. 10. As the panel 100a is created via injection molding, the shape of the plateau 304a and the matching cover die 312a define the resulting shape of the aperture 110a, as the plateau 304a and cover die 312a define the confining shape of the cavity 314a. The palnut 200 with the interior portion 202 shaped as a conventional hexagon would still fit within the modified “tapered” hexagonal design. In this example, the arcuate or concave sides of the plateau 304a result in an interior wall 108a having a plurality of concave segments defining the generally hexagonal aperture 110a. Thus, these convex sides of the interior wall 108 provide increased engagement along the first locations 214 of the flange 208.

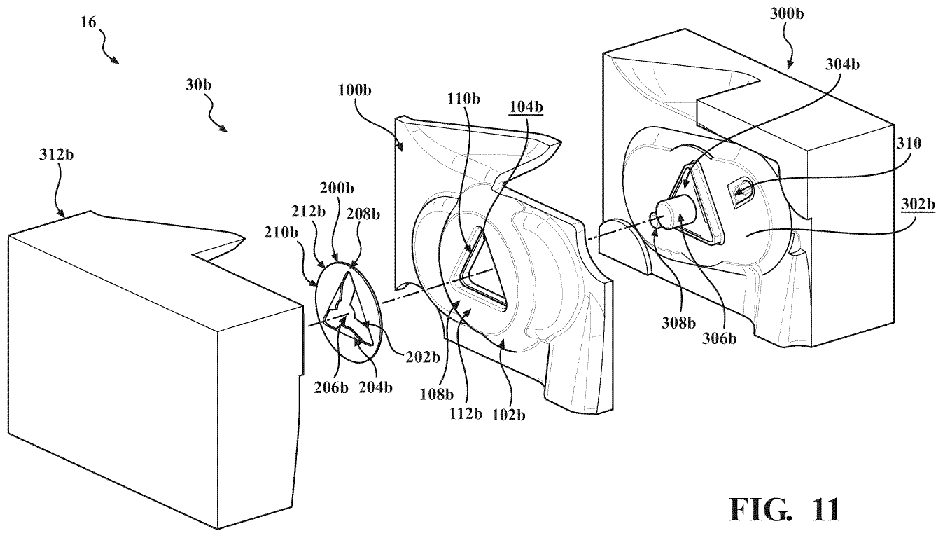

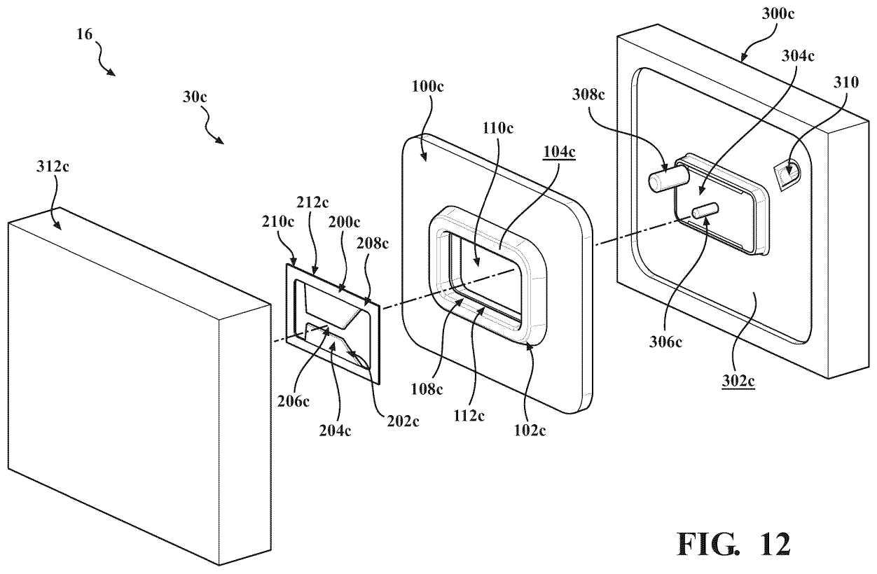

Referring to FIGS. 11 and 12, additional examples of mold assemblies 30b, 30c according to the principles of the present disclosure are provided. In these examples, the shapes of the apertures 110b, 110c could be a triangle or a rectangle, corresponding to a matching plateau 304b, 304c and cover die 312b, 312c shape. In these examples, where the shape of the aperture 110b, 110c is more significantly modified, the palnut 200b, 200c will also have to be selected to correspond to the triangular and rectangular shape, respectively. The design of the palnut 200b, 200c means that shape and configuration changes may be required for the interior portion 202b, 202c, the teeth 204b, 204c, the fastener opening 206b, 206c, the flange 208b, 208c, the peripheral edge 210b, 210c, and the perimeter 212b, 212c. Again, the same concepts described above can apply to multiple configurations while achieving the same results, each configuration able to accommodate the specific nature and application of the automotive component 12.

In operation, the panel assembly 14 requires a means to be fastened to the rest of the automotive component 12, or potentially, attach pieces of the automotive component 12 together, depending on the specific application. Integrating the palnut 200 within the panel assembly 14 fulfills this requirement, and this integration can be facilitated through an injection molding process that may be used to manufacture the panel 100. The panel assembly system 16 includes the necessary elements required to facilitate this process. With reference again to FIG. 5 and FIG. 6, the palnut 200 is placed on the ejector die 300. The center post 306 extends through the fastener opening 206 and the orientation post 308 extends through the space between the teeth 204. In this example, keeping in mind that multiple shapes may be used to achieve the same result, the orientation post 308 orients the hexagonal shape of the interior portion 202 to align with the matching hexagonal shape of the plateau 304. During the injection molding process, the plateau 304 defines the shape of the interior wall 108 as well as the shape of the aperture 110. Aligning the shape of the plateau 304 to the shape of the interior portion 202 of the palnut 200 positions the entirety of the interior portion 202 within the aperture 110, which allows the teeth 204 to flex and accommodate the threads of a fastener, such as a bolt. Furthermore, the orientation post 308 prevents the palnut 200 from spinning during the injection molding process. In this example, a spinning palnut 200 during injection molding would prevent the injection molding process from successfully occurring, as the spinning action would prevent the interior wall 108 and the aperture 110 to form into a hexagonal shape that matches the shape of the interior portion 202 of the palnut 200. If the shape of the interior wall 108 and the aperture 110 do not match the shape of the interior portion 202, the palnut 200 would not be mechanically locked within the panel body 102, creating the potential for the palnut 200 to spin while attempting to install a mechanical fastener in the fastener opening 206. This would make installing a mechanical fastener in the fastener opening 206 much more challenging compared to the desired result of the palnut 200 being mechanically locked within the panel body 102 and unable to spin.

With reference again to FIGS. 7-9, once the palnut 200 is in the correct position on the ejector die 300, the cover die 312 is installed over the palnut 200, mating with the ejector die 300, and creating a cavity 314. Only the flange 208 extends within the bounds of the cavity 314, sealing the entirety of the interior portion 202 outside the bounds of the cavity 314, allowing the interior portion 202 to be unaffected by the injection molding process. When the ejector die 300 is mated to the cover die 312, with the palnut 200 encapsulated between the ejector die 300 and the cover die 312, the injection molding process is ready to begin. A liquid plastic or resin is injected into the cavity 314 via the injection port 310 until the entirety of the cavity 314 is filled with the liquid plastic. Once the plastic cures and solidifies over a period of time, the ejector die 300 and the cover die 312 are removed and the result is the creation of the panel 100. Because the flange 208 is contained within the boundary of the cavity 314, the flange 208 creates the channel 112 disposed in the interior wall 108 of the panel 100. Furthermore, the shape of the plateau 304 and shape of the cover die 312 define the resulting shape of the interior wall 108 and the shape of the aperture 110.

With reference again to FIG. 2 and FIG. 3, once the injection molding process is complete and the liquid plastic has cured and solidified, the panel assembly 14 is formed. The flange 208 is embedded within the panel body 102, extending a variable flange width W₂₀₈ into the panel body 102 via the channel 112. The interior portion 202 of the palnut 200 is free and clear of the panel body 102 and contained entirely within the bounds of the aperture 110. Because the flange 208 is molded into the panel body 102, the palnut 200 cannot fall out or become dislodged from the panel 100. Furthermore, in this example, due to the hexagonal shape of the interior portion 202 of the palnut 200 that matches the hexagonal shape of the interior wall 108, combined with the teeth 204 being slightly biased upwardly or downwardly from the flange 208, the palnut 200 is unable to spin when in this described position. This allows the panel assembly 14 to be installed in its specific automotive component 12 application via a fastener bolt through the fastener opening 206 without risking the palnut 200 falling out of the panel 100 or spinning within the panel 100. Additionally, the panel assembly 14 may be shipped from its site of manufacture to the vehicle assembly plant without risking the palnut 200 becoming dislodged or falling out of the panel assembly 14.

With reference again to FIGS. 10-12, this operation may be performed identically as described with a modified shape and design to the palnut 200, the ejector die 300, the cover die 312, and the resulting panel 100 after the injection molding process occurs. The varying designs may configure to different applications and spatial requirements within a specific automotive component 12.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A panel assembly for an automotive component, the panel assembly comprising:
a panel including a panel body having a first side and a second side formed on an opposite side from the first side, and an interior wall extending between the first side and the second side to define an aperture extending at least partially through the panel body, the interior wall including a channel formed therein; and
a palnut including an interior portion having a plurality of teeth cooperating to define a fastener opening and a flange surrounding the interior portion, the flange received within the channel formed in the interior wall of the body.

2. The panel assembly of claim 1, wherein the palnut is a PV style palnut.

3. The panel assembly of claim 1, wherein the flange defines a flange width extending radially outwardly from the interior portion to a peripheral edge, the flange width being variable along a perimeter of the palnut.

4. The panel assembly of claim 1, wherein the plurality of teeth are arranged in a hexagon orientation and define the fastener opening.

5. The panel assembly of claim 1, wherein the palnut is one of a triangular palnut or a rectangular palnut.

6. The panel assembly of claim 1, wherein the aperture of the panel body has a hexagonal cross-sectional shape.

7. The panel assembly of claim 1, wherein the flange of the palnut extends a first distance into the panel body at a first location of the palnut and a different second distance into the panel body at a second location of the palnut.

8. A panel assembly system for an automotive component, the system comprising:
a mold assembly including:
an ejector die including a surface, a plateau disposed on the surface, a center post disposed on the plateau, and an orientation post disposed on the plateau and offset from the center post, and
a cover die; and
a palnut including an interior portion having a plurality of teeth cooperating to define a fastener opening and a flange surrounding the interior portion, the center post received in the fastener opening and the orientation post received between adjacent ones of the plurality of the teeth.

9. The system of claim 8, wherein the ejector die and the cover die mate together to form a cavity.

10. The system of claim 8, wherein the palnut is a PV style palnut.

11. The system of claim 8, wherein the flange defines a flange width extending radially outwardly from the interior portion to a peripheral edge, the flange width being variable along a perimeter of the palnut.

12. The system of claim 8, wherein the plurality of teeth are arranged in a hexagon orientation and define the fastener opening.

13. The system of claim 8, wherein the fastener opening is sized to accept the center post, and a space between the plurality of teeth is sized to accept the orientation post.

14. The system of claim 8, wherein the palnut is one of a triangular palnut or a rectangular palnut.

15. A method of making a panel assembly for an automotive component, the method comprising:
fixing a palnut to an ejector die, the palnut including an interior portion having a plurality of teeth cooperating to define a fastener opening and a flange surrounding the interior portion;
mating a cover die to the ejector die, mating the cover die to the ejector die forming a cavity;
injecting liquid plastic into the cavity via an injection port disposed in the ejector die to form a panel body at least partially encapsulating the flange of the palnut;
allowing the liquid plastic to cure and solidify over a period of time within the cavity, resulting in a panel; and
removing the ejector die and the cover die from the panel.

16. The method of claim 15, wherein the interior portion of the palnut is located outside of the cavity.

17. The method of claim 15, wherein the flange defines a flange width extending radially outwardly from the interior portion to a peripheral edge, the flange width being variable along a perimeter of the palnut.

18. The method of claim 15, wherein the flange of the palnut is located within the cavity.

19. The method of claim 15, wherein the ejector die includes a plateau and a center post extending from the plateau, and wherein the method further includes arranging the palnut on the plateau with the center post received within the fastener opening.

20. The method of claim 19, wherein the ejector die further includes an orientation post extending from the plateau and offset from the center post, and wherein the method further includes arranging the palnut on the plateau with the orientation post received between adjacent ones of the teeth.
